(19) United States
(12) Patent Application Publication
(10) Pub. No.: US 2020/0378187 A1
(43) Pub. Date: Dec. 3, 2020

(54) Ladder Locking Apparatus

(71) Applicant: Timothy Payton, Coral Springs, FL (US)

(72) Inventor: Timothy Payton, Coral Springs, FL (US)

(21) Appl. No.: 16/889,315

(22) Filed: Jun. 1, 2020

Related U.S. Application Data
(60) Provisional application No. 62/854,442, filed on May 30, 2019.

(51) Int. Cl. E06C 7/48; F16M 13/02

(52) U.S. Cl. CPC E06C 7/48; F16M 13/02

(57) ABSTRACT

The present invention is a safety device that secures a ladder to a rooftop, preventing the ladder from dislodging off the rooftop. The ladder lock apparatus includes a ladder lock body, a locking pin, and at least one anchor fastener. The ladder lock body contains an anchor end, a ladder receiving end, an anchor plate, a ladder receiver, at least one locking aperture, and at least one anchor aperture. The anchor plate is positioned opposite to the ladder receiver along the anchor plate. The locking aperture traverses through the ladder receiver. The locking pin is removably positioned within the locking aperture. The at least one anchor aperture is distributed about the anchor plate. Each of the at least one anchor fastener is removably positioned within one of the at least one anchor aperture. The anchor plate is removably attached to the rooftop through the at least one anchor fastener.

The current application claims a priority to the U.S. Provisional Patent application Ser. No. 62/854,442 filed on May 30, 2019. The current application is filed on Jun. 1, 2020 while May 30, 2020 and May 31, 2020 were on a weekend.

### FIELD OF THE INVENTION

The present invention relates to safety devices. More specifically, the present invention relates to a ladder locking safety device.

### BACKGROUND OF THE INVENTION

Safety devices are often employed at construction sites as a means to provide safety to construction workers. Safety rails, safety locks, safety brackets and any other suitable safety device may be deployed to secure a potential hazard. One potential hazard is ladder tipping. Oftentimes, accidents occur from said ladders swaying or tipping off of the edge of the rooftop. This results in the individual getting stuck and/or injured. Conventional systems known in the art include rope and/or bungee cord tie-downs that hold the ladder on to the edge of the rooftop, but are often primitive and grossly outdated, especially when trying to meet any type of safety guideline. Therefore, it is an objective of the present invention to provide a safety device that can effectively secure a ladder to a rooftop.

The present invention aims to provide a better solution. The present invention is a compact, lightweight, solid, and robust ladder locking apparatus that effectively secures the ladder on to a rooftop. Installation of the present invention only requires a corresponding hand-drill and bit to securely attach the present invention on to the edge of the rooftop. Additionally, the present invention installs in less than a minute and requires little to no expertise on how to handle the device. Furthermore, the present invention can also be left on top of the rooftop to serve as a hanger piece for whatever the user desires.

### SUMMARY OF THE INVENTION

A ladder lock apparatus comprises a ladder lock body, a locking pin, and at least one anchor fastener. The ladder lock apparatus allows a user to secure any ladder to any rooftop job site. Once the job is finished, the ladder lock apparatus is removed by the user for the next rooftop contract. The ladder lock body comprises an anchor end, a ladder receiving end, an anchor plate, a ladder receiver, at least one locking aperture, and at least one anchor aperture. The anchor end and the ladder receiving end are terminally positioned opposite to each other along the ladder lock body. The anchor end is positioned opposite to the ladder receiver along the anchor plate. The at least one locking aperture traverses through the ladder receiver. In the preferred embodiment of the present invention, the ladder receiver receives and secures the ladder. The locking pin is removably positioned within the locking aperture. Additionally, the locking pin serves as an anti-theft deterrent for the ladder lock apparatus, such that the locking pin locks the installed ladder along the ladder lock apparatus. The at least one anchor aperture is distributed about the anchor plate and traverses through the anchor plate. Each of the at least one anchor fastener is removably positioned within one of the at least one anchor aperture. The anchor plate is removably attached to the rooftop through the at least one anchor fastener.

### BRIEF DESCRIPTION OF THE DRAWINGS

FIG. 1 is a perspective view of the present invention.

FIG. 2 is an exploded view of the present invention.

FIG. 3 is a side view of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

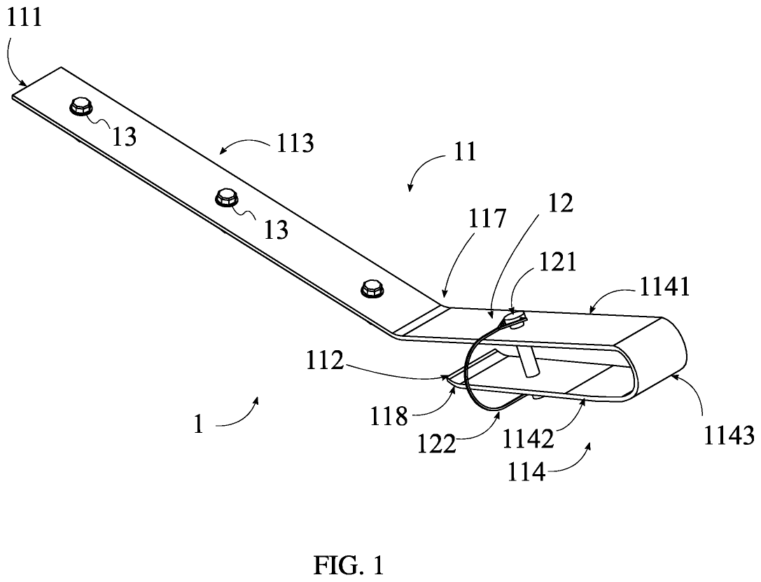

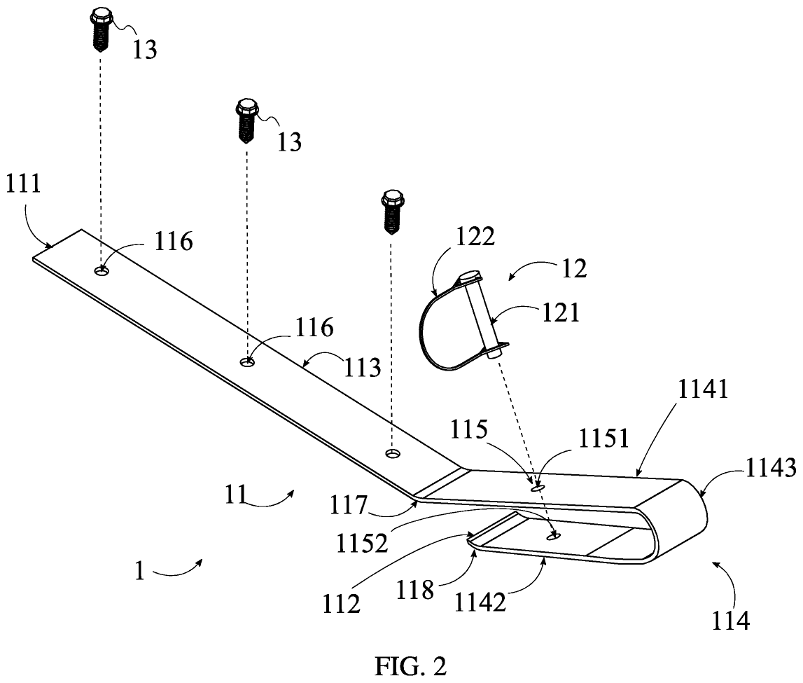

A ladder lock apparatus 1 comprises a ladder lock body 11, a locking pin 12, and at least one anchor fastener 13, as shown in FIGS. 1-3. The ladder lock apparatus 1 allows a user to secure any ladder to any rooftop job site. Once the job is finished, the ladder lock apparatus 1 is removed by the user for the next rooftop contract. In the preferred embodiment of the present invention, the ladder lock body 11 may take the form of a one-piece construction made out of durable and corrosion resistant aluminum, but may take the form of any other suitable material, such as, but not limited to steel, fiberglass, or any other suitable material. The ladder lock body 11 comprises an anchor end 111, a ladder receiving end 112, an anchor plate 113, a ladder receiver 114, at least one locking aperture 115, and at least one anchor aperture 116, as shown in FIG. 2. The anchor end 111 and the ladder receiving end 112 are terminally positioned opposite to each other along the ladder lock body 11. The anchor end 111 is positioned opposite to the ladder receiver 114 along the anchor plate 113. The at least one locking aperture 115 traverses through the ladder receiver 114. In the preferred embodiment of the present invention, the ladder receiver 114 receives and secures the ladder.

In the preferred embodiment of the present invention, the locking pin 12 is removably positioned within the locking aperture. In the preferred embodiment of the present invention, the locking pin 12 may take the form of any suitable locking implement to prevent the ladder from dislodging from the ladder lock apparatus 1 such as, but not limited to hitch pins, pin locks, bolts, or any other suitable locking implement. Additionally, the locking pin 12 serves as an anti-theft deterrent for the ladder lock apparatus 1, such that the locking pin 12 locks the installed ladder along the ladder lock apparatus 1. The at least one anchor aperture 116 is distributed about the anchor plate 113. The at least one anchor aperture 116 traverses through the anchor plate 113. Each of the at least one anchor fastener 13 is removably positioned within one of the at least one anchor aperture 116. The anchor plate 113 is removably attached to the rooftop through the at least one anchor fastener 13. In the preferred embodiment of the present invention, each of the at least one anchor fastener 13 is a lag bolt but may take the form of any other suitable fastener, such as, but not limited to nails, clips, or any other suitable fastener.

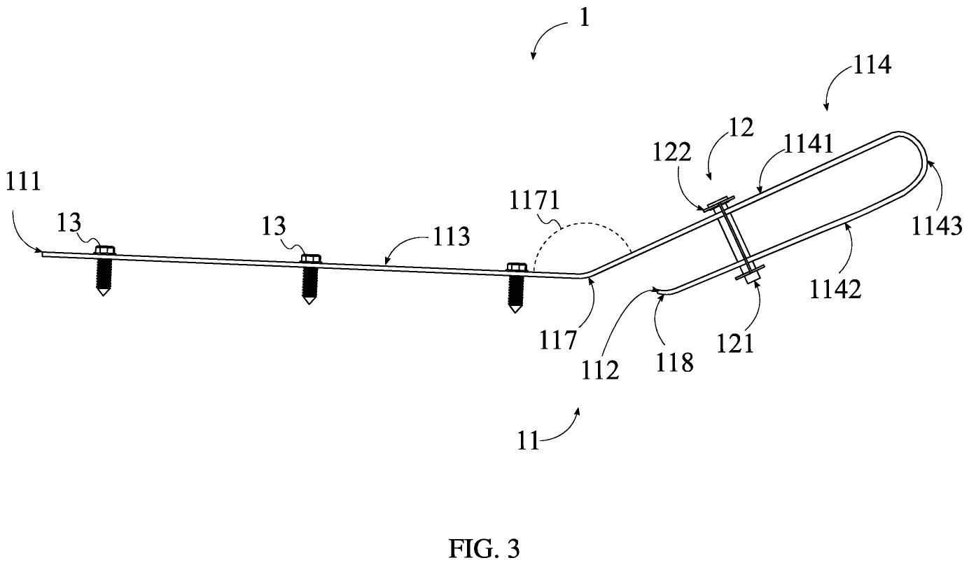

In the preferred embodiment of the present invention, the ladder lock body 11 further comprises a flange bend 117, as shown in FIGS. 1-3. The flange bend 117 is positioned between the anchor plate 113 and the ladder receiver 114. The flange bend 117 comprises a specified angle 1171, as shown in FIG. 3. The anchor plate 113 and the ladder receiver 114 are connected to each other through the flange bend 117 at the specified angle 1171. In the preferred embodiment of the present invention, the specified angle 1171 may take the form of an obtuse degree, such that the anchor plate 113 touches the rooftop and the ladder receiver 114 loops round one of the ladder steps.

In the preferred embodiment of the present invention, the at least one locking aperture 115 comprises a first locking aperture 1151 and a second locking aperture 1152, as shown in FIG. 2. The ladder receiver 114 comprises a first receiving flange 1141, a second receiving flange 1142, and a hem portion 1143, as shown in FIGS. 1-3. The first receiving flange 1141 is positioned terminally adjacent to the flange bend 117, opposite to the anchor plate 113. The hem portion 1143 is positioned terminally adjacent to the first receiving flange 1141, opposite to the flange bend 117. The second receiving flange 1142 is positioned terminally adjacent to the hem portion 1143, opposite to the first receiving flange 1141. The second receiving flange 1142 is oriented parallel to the first receiving flange 1141. The first locking aperture traverses through the first receiving flange 1141. The second locking aperture traverses through the second receiving flange 1142. The first locking aperture and the second locking aperture is concentrically aligned to each other.

In the preferred embodiment of the present invention, the ladder lock body 11 further comprises a bowed portion 118, as shown in FIGS. 1-3. The bowed portion 118 is positioned terminally adjacent to the ladder receiving end 112. The bowed portion 118 is positioned terminally adjacent to the second receiving flange 1142, opposite to the hem portion 1143. The bowed portion 118 prevents the ladder receiver 114 end from digging into the rooftop when the ladder lock apparatus 1 is installed. In the preferred embodiment of the present invention, the locking pin 12 comprises a pin body 121 and a retention clip 122, as shown in FIGS. 1-3. The retention clip 122 is operatively engaged to the pin body 121, where the locking pin 12 is removably attached within the at least one locking aperture 115 through the retention clip 122.

Although the invention has been explained in relation to its preferred embodiment, it is to be understood that many other possible modifications and variations can be made without departing from the spirit and scope of the invention as hereinafter claimed.

What is claimed is:

1. A ladder lock apparatus comprising:
a ladder lock body;
a locking pin;
at least one anchor fastener;
the ladder lock body comprising an anchor end, a ladder receiving end, an anchor plate, a ladder receiver, at least one locking aperture, and at least one anchor aperture; the anchor end and the ladder receiving end being terminally positioned opposite to each other along the ladder lock body;
the anchor end being positioned opposite to the ladder receiver along the anchor plate;
the at least one locking aperture traversing through the ladder receiver;
the locking pin being removably positioned within the locking aperture;
the at least one anchor aperture being distributed about the anchor plate;
the at least one anchor aperture traversing through the anchor plate; and
each of the at least one anchor fastener being removably positioned within one of the at least one anchor aperture.

2. The ladder lock apparatus as claimed in claim 1 comprising:
the ladder lock body further comprising a flange bend; and
the flange bend being positioned between the anchor plate and the ladder receiver.

3. The ladder lock apparatus as claimed in claim 2 comprising:
the flange bend comprising a specified angle; and
the anchor plate and the ladder receiver being connected to each other through the flange bend at the specified angle.

4. The ladder lock apparatus as claimed in claimed 2 comprising:
the at least one locking aperture comprising a first locking aperture and a second locking aperture;
the ladder receiver comprising a first receiving flange, a second receiving flange, and a hem portion;
the first receiving flange being positioned terminally adjacent to the flange bend, opposite to the anchor plate;
the hem portion being positioned terminally adjacent to the first receiving flange, opposite to the flange bend;
the second receiving flange being positioned terminally adjacent to the hem portion, opposite to the first receiving flange;
the second receiving flange being oriented parallel to the first receiving flange;
the first locking aperture traversing through the first receiving flange;
the second locking aperture traversing through the second receiving flange; and
the first locking aperture and the second locking aperture being concentrically aligned to each other.

5. The ladder lock apparatus as claimed in claimed 1 comprising:
the ladder lock body further comprising a bowed portion; and
the bowed portion being positioned terminally adjacent to the ladder receiving end.

6. The ladder lock apparatus as claimed in claimed 4 comprising:
the ladder lock body further comprising a bowed portion; and
the bowed portion being positioned terminally adjacent to the second receiving flange, opposite to the hem portion.

7. The ladder lock apparatus as claimed in claimed 1 comprising:
the locking pin comprising a pin body and a retention clip; and
the retention clip being operatively engaged to the pin body, wherein the locking pin is removably attached within the at least one locking aperture through the retention clip.

8. The ladder lock apparatus as claimed in claimed 1, wherein each of the at least one anchor fastener is a lag bolt.
